(19) United States
(12) Patent Application Publication
(10) Pub. No.: US 2026/0218899 A1
(43) Pub. Date: Jul. 30, 2026

(54) CORROSION-INHIBITED ORGANIC WASTE SUPERCRITICAL HYDROTHERMAL COMBUSTION TREATMENT SYSTEM

(71) Applicant: Xi'an Jiaotong University, Xi'an (CN)

(72) Inventors: Yanhui Li, Xi'an (CN); Wang Zhu, Xi'an (CN); Qibo Wang, Xi'an (CN); Shuzhong Wang, Xi'an (CN); Zhouyang Bai, Xi'an (CN); Limei Xing, Xi'an (CN); Shaoming Ding, Xi'an (CN)

(21) Appl. No.: 19/394,945

(22) Filed: Nov. 20, 2025

(30) Foreign Application Priority Data
Jan. 25, 2025 (CN) 2025101203694

(51) Int. Cl. F23G 5/48; B01D 53/22

(52) U.S. Cl. CPC F23G 5/48; B01D 53/229; B01D 2256/16

(57) ABSTRACT

A corrosion-inhibited organic waste supercritical hydrothermal combustion treatment system is provided, which relates to the technical field of harmless treatment of organic waste. To address the severe corrosion issues in existing supercritical hydrothermal combustion treatment systems and the resource waste after treatment, the corrosion-inhibited organic waste supercritical hydrothermal combustion treatment system is provided. Based on meeting the requirements for supercritical hydrothermal combustion of organic waste, the system achieves low-cost mitigation of corrosion in both the preheating and cooling sections of a subcritical zone in the supercritical hydrothermal combustion treatment system by injecting supercritical water and incorporating a hydrogen supply unit. Additionally, the issue of resource waste is resolved through the recovery and reuse of hydrogen within the system.

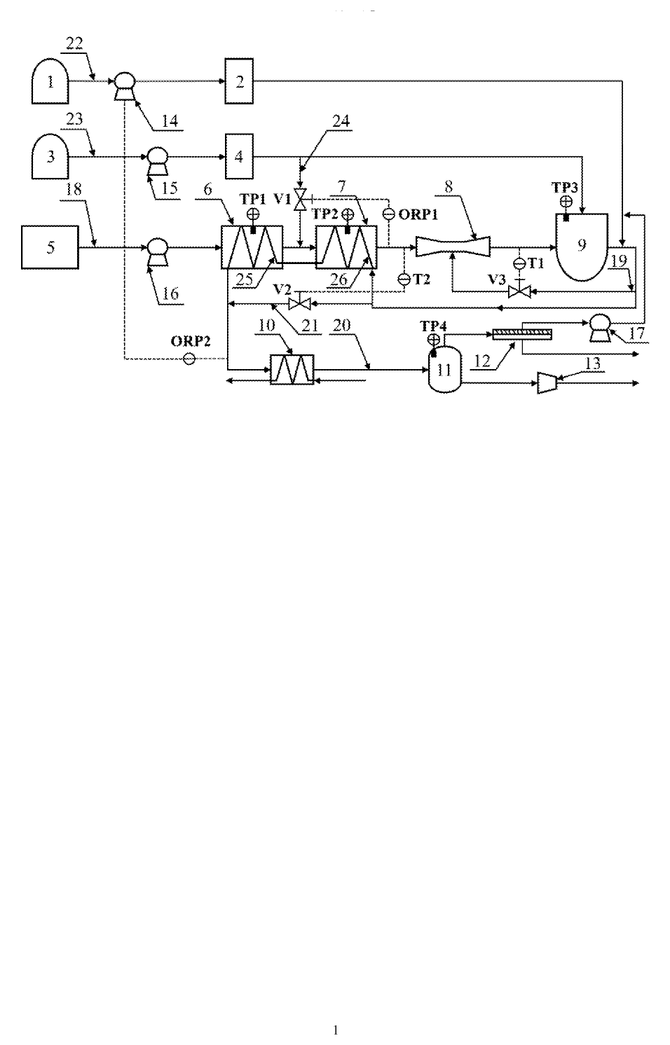

### TECHNICAL FIELD

The disclosure relates to the technical field of harmless treatment of organic waste, and more particularly to a corrosion-inhibited organic waste supercritical hydrothermal combustion treatment system.

### BACKGROUND

Currently, the massive generation of high-salinity and high-concentration organic waste, coupled with the difficulty in its proper treatment, has severely endangered public health and safety. This issue represents a challenging, critical, and focal point in China's industrial waste treatment. Supercritical water oxidation (SCWO) technology is an efficient waste treatment method that utilizes the unique physical and chemical properties of supercritical water. Under high temperature (typically above 374.3℃) and high pressure (typically above 22.064 megapascals abbreviated as MPa), the fundamental properties of water, such as density, viscosity, electrical conductivity, and dielectric constant, undergo significant changes. This enables complete mutual dissolution of organic matter and oxygen, facilitating rapid oxidative decomposition of organics. When the organic waste undergoes a vigorous oxidation reaction with oxygen, it will produce a distinct hydrothermal flame. This technology for treating the organic waste is known as supercritical hydrothermal combustion (SCHC). The SCHC technology can effectively treat various toxic and hazardous organic wastewater and waste, including exhaust gases, wastewater, and solid waste discharged from factories, as well as the disposal of obsolete chemical weapons in military applications.

Despite advantages such as fast reaction rates and thorough treatment, the SCHC technology still faces several challenging issues in practical applications. The most prominent and unavoidable problem is equipment corrosion. The high-temperature and high-pressure operating conditions impose stringent requirements on equipment materials, and currently, no metal material can completely avoid corrosion under supercritical water conditions. Particularly in supercritical water environments containing high concentrations of oxidants, metal corrosion rates are significantly higher than under normal conditions. Equipment must not only endure high-temperature and high-pressure operational conditions but also handle various organic wastes containing highly aggressive ions. As a result, corrosion in supercritical hydrothermal combustion treatment systems is a severe issue, which not only compromises the efficiency of organic waste treatment but may also jeopardize the normal operation of the entire system.

Furthermore, in subcritical zones, the ion product of water reaches its maximum around 280℃. Within this temperature range, the high concentrations of H⁺ and OH⁻ ions accelerate metal corrosion through ionic reactions, with corrosion being predominantly electrochemical. This is the primary reason for intensified corrosion in subcritical water, often making it more severe than in supercritical water. Since a preheating section and a cooling section following a reactor in the supercritical hydrothermal combustion treatment systems include subcritical zones, preheaters and coolers in the supercritical hydrothermal combustion treatment systems often face the most severe corrosion problems.

In currently known SCHC technologies, the common approach to address equipment corrosion is the use of more expensive metal materials for manufacturing SCHC equipment. However, controlling corrosion remains challenging. Corrosion has become a major factor hindering the development of the SCHC technology. Additionally, the inability to reuse resources after SCHC treatment further complicates the issue. These problems collectively impede the further advancement of the SCHC technology.

### SUMMARY

In order to solve the serious corrosion problem of the current supercritical hydrothermal combustion treatment system and the waste of resources after supercritical hydrothermal combustion treatment, the disclosure provides a corrosion-inhibited organic waste supercritical hydrothermal combustion treatment system. On the basis of meeting the requirements of supercritical hydrothermal combustion treatment of organic wastes, the corrosion problem of a preheating section and a cooling section of a subcritical zone of the supercritical hydrothermal combustion treatment system is solved at low cost by injecting supercritical water and adding a hydrogen supply unit. The preheating section of the subcritical zone of the supercritical hydrothermal combustion treatment system consists of a second-stage preheater, an ejector and a first pipeline between the second-stage preheater and the ejector. An outer pipeline of the preheater is the cooling section of the subcritical zone of the supercritical hydrothermal combustion treatment system. The problem of resource waste is solved by recycling hydrogen in the corrosion-inhibited organic waste supercritical hydrothermal combustion treatment system.

In order to achieve the above purpose, technical solutions of the disclosure are as follows.

Specifically, a corrosion-inhibited organic waste supercritical hydrothermal combustion treatment system includes: a reactor, an organic waste tank, an oxidant supply unit, a hydrogen supply unit, and a membrane separator.

The reactor is configured to perform supercritical hydrothermal combustion treatment on the organic wastes.

The organic waste tank is configured to supply the organic wastes to the reactor. The organic waste tank and the reactor are connected via a first pipeline, and the first pipeline is sequentially provided with a first-stage preheater, a second-stage preheater, and an ejector. A material outlet end of the reactor is further connected to the ejector via a second pipeline, and the ejector is configured to inject supercritical thermal fluid from the material outlet end of the reactor. The organic wastes are preheated by the first-stage preheater and the second-stage preheater to obtain preheated organic wastes. After the preheated organic wastes are mixed with the high-temperature and high-pressure supercritical thermal fluid, the subcritical temperature section can be bypassed, thereby avoiding the problem of severe corrosion in the subcritical zone.

The oxidant supply unit is configured to provide oxygen for the supercritical hydrothermal combustion treatment. The oxidant supply unit is further configured to introduce the oxygen into the first pipeline between the first-stage preheater and the second-stage preheater during supplying the oxygen to the reactor.

The hydrogen supply unit is configured to provide hydrogen to reduce an oxidation-reduction potential of the cooling section of the subcritical zone of the supercritical hydrothermal combustion treatment system, and the hydrogen supply unit is connected to the material outlet end of the reactor.

Taking the membrane separator as a hydrogen recovery bypass, the hydrogen supply unit and the hydrogen recovery bypass together form a hydrogen injection unit, which is used to recover hydrogen in the corrosion-inhibited organic waste supercritical hydrothermal combustion treatment system. The membrane separator is arranged on a third pipeline, one end of which is connected to the material outlet end of the reactor and the other end is connected to an outlet of the hydrogen supply unit. A product separator is further arranged on the third pipeline between the reactor and the membrane separator, and a gas phase product outlet and a non-gas phase product outlet are arranged on the product separator.

The third pipeline is connected to a fourth pipeline, a second switch valve is installed on the fourth pipeline, and an outer pipeline of each of the first-stage preheater and the second-stage preheater is a subcritical zone cooling section.

In the disclosure, the first-stage preheater, the second-stage preheater, the reactor and the product separator form an organic waste oxidation unit. The outlet of the second-stage preheater is connected to the reactor by the ejector, and the gas phase product outlet of the product separator is connected to the inlet of the membrane separator. According to the disclosure, various organic wastes are subjected to supercritical hydrothermal combustion treatment through the organic waste oxidation unit, so that the harmless treatment of the organic wastes is realized, and the non-gas phase products generated by the subsequent treatment can be harmlessly discharged or reused. At the same time, the heat of the first-stage preheater and the second-stage preheater comes from the high-temperature and high-pressure supercritical thermal fluid at the material outlet end of the reactor, and the waste heat is recovered and reused through the first-stage preheater and the second-stage preheater, which has high economic benefits. The hydrogen injection unit and the oxidant supply unit not only ensure the safe operation of the system, but also solve the serious corrosion problem in the subcritical zone of the inner and outer pipelines of the first-stage preheater and the second-stage preheater.

In an embodiment, the hydrogen supply unit includes a liquid hydrogen tank and a liquid hydrogen vaporizer, the liquid hydrogen tank is connected to the material outlet end of the reactor via a fifth pipeline, the liquid hydrogen vaporizer is disposed on the fifth pipeline, and a liquid hydrogen pump is further provided on the fifth pipeline between the liquid hydrogen tank and the liquid hydrogen vaporizer.

The third pipeline and the outlet end of the membrane separator are connected to the fifth pipeline, and the third pipeline between the membrane separator and the fifth pipeline is also provided with a pressurizing pump. On the one hand, the membrane separator realizes the recovery of hydrogen, on the other hand, it discharges gas-phase products other than hydrogen. The disclosure uses the special physical and chemical properties of supercritical water to carry out continuous harmless treatment on organic wastes, thus solving the pain points and difficulties that organic wastes are difficult to treat at present, and carrying out harmless discharge and resource reuse on the treated products.

In an embodiment, a feedwater heater is further arranged on the third pipeline between the reactor and the product separator, and the feedwater heater is used to heat the water outside the system. In the disclosure, the first-stage preheater, the second-stage preheater and the feedwater heater are used as waste heat recovery units, and the high-temperature and high-pressure supercritical thermal fluid at the outlet of the reactor is not only used as the heat source in the preheating section of the corrosion-inhibited organic waste supercritical hydrothermal combustion treatment system, but also can deeply utilize the waste heat of the external feedwater.

In an embodiment, a second oxidation-reduction potential meter is provided at an inlet end of the feedwater heater, and the second oxidation-reduction potential meter is interlocked with the liquid hydrogen pump. The second oxidation-reduction potential meter of the disclosure monitors the potential of the mixture of the cooling fluid and the high-temperature and high-pressure supercritical thermal fluid before the separation of the product separator, and solves the problem of excessive oxidant in the high-temperature and high-pressure supercritical thermal fluid at the outlet of the reactor by adjusting the opening of the liquid hydrogen pump, thus solving the problem of severe oxidation and corrosion of the outer pipeline of the preheater. By controlling the hydrogen supply volume from the hydrogen supply unit, the oxidation-reduction potential of the cooling fluid at the outlet of the outer pipeline of the first-stage preheater is maintained at or below –0.2 V, ensuring that the electrochemical potential of the metallic material in the outer pipeline remains within its passivation range.

In an embodiment, the oxidant supply unit includes a liquid oxygen tank and a liquid oxygen vaporizer, the liquid oxygen tank is connected to the reactor via a sixth pipeline, the liquid oxygen vaporizer is disposed on the sixth pipeline, and a liquid oxygen pump is further provided on the sixth pipeline between the liquid oxygen tank and the liquid oxygen vaporizer.

In an embodiment, a seventh pipeline is arranged between the sixth pipeline and the first pipeline, the seventh pipeline is located between the first-stage preheater and the second-stage preheater, a first switch valve is provided on the seventh pipeline, a first oxidation-reduction potential meter is provided at an outlet end of the second-stage preheater, and the first oxidation-reduction potential meter is interlocked with the first switch valve. The middle section of the preheater is supplied with oxygen by the liquid oxygen pump, the liquid oxygen vaporizer and the first switch valve. By supplying oxygen to the middle section of the preheater, the organic waste is partially oxidized in the first pipeline, and the heat generated by oxidation promotes the preheating process of the second-stage preheater, which also solves the problem that the organic waste in the second-stage preheater contains too many reducing substances and effectively prevents the risk of hydrogen embrittlement cracking in the second-stage preheater. By adjusting the opening of the first switch valve, the oxidation-reduction potential at the outlet of the second-stage preheater is maintained at no less than –0.7 V, thereby mitigating the risk of stress corrosion cracking caused by hydrogen embrittlement within the second-stage preheater.

In an embodiment, a third switch valve is arranged on the second pipeline, and a first thermometer is arranged at the inlet end of the reactor between the ejector and the reactor, and the first thermometer is interlocked with the third switch valve. The first thermometer of the disclosure can adjust and control the amount of supercritical water injected at the outlet of the ejector, and ensure that the preheated organic waste at the outlet of the second-stage preheater can skip the subcritical corrosion risk zone after being mixed with high-temperature and high-pressure supercritical thermal fluid.

In an embodiment, a second switch valve is arranged on the third pipeline between the second-stage preheater and the first-stage preheater, and a second thermometer is arranged at the inlet end of the ejector between the second-stage preheater and the ejector, and the second thermometer is interlocked with the second switch valve. The second thermometer of the disclosure monitors the temperature at the outlet of the second-stage preheater, and prevents the organic waste from heating up too high in the first-stage preheater and the second-stage preheater by adjusting the opening of the second switch valve. The second thermometer controls the outlet temperature of the second-stage preheater to ensure it does not exceed 270℃.

In an embodiment, each of the first-stage preheater, the second-stage preheater, the reactor, and the product separator is internally provided with an integrated temperature and pressure sensor to ensure the safe operation of the system.

In an embodiment, the product separator is connected to a pressure reducer. The product entering the product separator still has a certain temperature and pressure. In order to solve the problem that the harmless discharge pressure of the product separator is too high, the product separator is further connected to the pressure reducer, and the gas phase product separated by the product separator enters the membrane separator for hydrogen recovery and reuse, and the outlet of the pressure reducer discharges the harmless product to the outside, and the non-gas phase product is discharged to the outside under the action of the pressure reducer.

The disclosure also provides a treatment method based on the corrosion-inhibited organic waste supercritical hydrothermal combustion treatment system, which includes steps as follows.

The organic waste in the organic waste tank is preheated by the first-stage preheater and the second-stage preheater in turn to obtain preheated organic waste, and the preheated organic waste is mixed with the high-temperature and high-pressure supercritical thermal fluid discharged from the material outlet end of the reactor in the ejector and transported to the reactor.

After the oxygen in the liquid oxygen tank is discharged through the liquid oxygen pump and the liquid oxygen vaporizer in turn, one way is delivered to the reactor, and the other way is delivered to the first pipeline through the seventh pipeline.

The hydrogen in the liquid hydrogen tank is discharged through the liquid hydrogen pump and the liquid hydrogen vaporizer in turn, and then mixed with the high-temperature and high-pressure supercritical thermal fluid to obtain the corrosion-inhibited supercritical thermal fluid. The high-temperature and high-pressure supercritical thermal fluid coming out of the reactor usually has surplus oxidant, so the cooling section in the subcritical zone is seriously corroded. The main function of adding hydrogen is to consume surplus oxidant and reduce the oxidation-reduction potential of the cooling section in the subcritical zone to achieve the effect of corrosion inhibition.

The corrosion-inhibited supercritical thermal fluid is conveyed to the ejector through the second pipeline. Another path is conveyed through the third pipeline, and exchanges heat with the second-stage preheater and the first-stage preheater in turn to obtain cooling fluid. Still another path is transported through the fourth pipeline, and the mixing of the cooling fluid and the corrosion-inhibited supercritical thermal fluid is realized in the third pipeline, and they are sent to the feedwater heater to exchange heat with external water to obtain heat exchange fluid.

The heat exchange fluid is transported to the product separator, and the product separator discharges the gas phase products into the membrane separator for hydrogen recovery and reuse, and the non-gas phase products are discharged.

Compared with the related art, the disclosure has the beneficial effects as follows.

1. The corrosion-inhibited organic waste supercritical hydrothermal combustion treatment system of the disclosure includes the reactor, the organic waste tank, the oxidant supply unit, the hydrogen supply unit and the membrane separator. The oxidant supply unit provides oxygen for the supercritical hydrothermal combustion treatment, the hydrogen supply unit reduces the oxidation-reduction potential of the cooling section in the subcritical region of the supercritical hydrothermal combustion treatment system, and the membrane separator realizes the recovery of hydrogen in the organic waste supercritical hydrothermal combustion treatment system. The first-stage preheater, the second-stage preheater, the reactor and the product separator forms the organic waste oxidation unit, and various organic wastes are treated harmlessly through the organic waste oxidation unit.

The disclosure is provided with the two-stage preheater and the ejector, and after the preheated organic waste is mixed with the high-temperature and high-pressure supercritical thermal fluid, the subcritical temperature section can be skipped, so that the problem of serious corrosion of the preheating section in the subcritical zone is avoided. The disclosure also adds a hydrogen supply unit, and the hydrogen supply unit reduces the oxidation-reduction potential of the cooling section in the subcritical zone, thus solving the problem of serious corrosion of the cooling section in the subcritical zone. The disclosure also recycles the waste heat of the corrosion-inhibited supercritical thermal fluid in the corrosion-inhibited organic waste supercritical hydrothermal combustion treatment system through the first-stage preheater and the second-stage preheater, thus improving the operation efficiency of the whole system.

2. By introducing oxygen into the first pipeline between the first-stage preheater and the second-stage preheater, the disclosure solves the problem of hydrogen embrittlement caused by high reducing atmosphere in the inner tube of the second-stage preheater, and promotes the partial oxidation of organic wastes in advance and is also beneficial to the preheating of the second-stage preheater. The ejector can eject the high-temperature and high-pressure supercritical thermal fluid at the outlet of the reactor, and the preheated organic waste can skip the subcritical temperature section after mixing with the high-temperature and high-pressure supercritical thermal fluid, thus avoiding the problem of serious corrosion in the subcritical zone.

3. In the disclosure, hydrogen is supplied to the corrosion-inhibited organic waste supercritical hydrothermal combustion treatment system through the hydrogen supply unit, so that the surplus oxidant at the outlet of the reactor is consumed, the oxidation reduction potential of the cooling section in the subcritical zone is reduced, and the residual hydrogen of the product is recycled through the membrane separator, so that the problem of serious oxidation corrosion at the cooling section of the outlet of the reactor is alleviated while the product is recycled.

4. On the basis of ensuring the safe operation of the corrosion-inhibited organic waste supercritical hydrothermal combustion treatment system, the corrosion problem of the preheating section and corrosion section in the subcritical zone of the first-stage preheater and the second-stage preheater is solved by optimizing the process flow. The first-stage preheater, the second-stage preheater and the feedwater heater are arranged for waste heat recovery, so that the high-temperature and high-pressure supercritical thermal fluid is cooled and depressurized, and at the same time the heat required for preheating is provided to the first-stage preheater and the second-stage preheater. Finally, the hydrogen in the cooled fluid is carried out. The disclosure not only solves the corrosion problem of equipment, but also saves the running cost of the whole corrosion-inhibited organic waste supercritical hydrothermal combustion treatment system.

### BRIEF DESCRIPTION OF DRAWINGS

Figure is a system layout diagram of a corrosion-inhibited organic waste supercritical hydrothermal combustion treatment system according to an embodiment of the disclosure.

### Description of reference signs:

1. liquid hydrogen tank; 2. liquid hydrogen vaporizer; 3. liquid oxygen tank; 4. liquid oxygen vaporizer; 5. organic waste tank; 6. first-stage preheater; 7. second-stage preheater; 8. ejector; 9. reactor; 10. feedwater heater; 11. product separator; 12. membrane separator; 13. pressure reducer; 14. liquid hydrogen pump; 15. liquid oxygen pump; 16. material pump; 17. pressurizing pump; 18. first pipeline; 19. second pipeline; 20. third pipeline; 21. fourth pipeline; 22. fifth pipeline; 23. sixth pipeline; 24. seventh pipeline; 25. outer pipeline of the first-stage preheater; 26. outer pipeline of the second-stage preheater; V1. first switch valve; V2. second switch valve; V3. third switch valve; T1. first thermometer; T2. second thermometer; ORP1. first oxidation-reduction potential meter; ORP2. second oxidation-reduction potential meter, TP1, TP2, TP3, TP4. integrated temperature and pressure sensor.

### DETAILED DESCRIPTION OF EMBODIMENTS

In order to make the purpose, technical solutions and advantages of the disclosure clearer, the disclosure will be further described in detail with embodiments. It should be understood that the specific embodiments described here are only used to explain the disclosure, and are not used to limit the disclosure.

Based on the embodiments in the disclosure, all other embodiments obtained by those skilled in the art without creative labor belong to the scope of protection of the disclosure.

At present, although the supercritical hydrothermal combustion technology has the advantages of fast reaction speed and thorough treatment, the supercritical hydrothermal combustion treatment system not only faces the operating conditions of high temperature and high pressure, but also contains strong corrosive ions in various organic wastes. Therefore, the corrosion problem of the supercritical hydrothermal combustion treatment system is very serious, which not only affects the treatment quality, but also may affect the normal work of the system. The corrosion in subcritical water is often more serious than that in supercritical water, and there are subcritical zones in the preheating section and cooling section of supercritical hydrothermal combustion treatment system, so the preheater and cooler in supercritical hydrothermal combustion treatment system often face the most serious corrosion problems. Based on this, a corrosion-inhibited organic waste supercritical hydrothermal combustion treatment system of the disclosure introduces hydrogen, and the hydrogen is added to consume the surplus oxidant, so as to reduce the oxidation-reduction potential of the cooling section in the subcritical zone to achieve the corrosion inhibition effect. The disclosure is also provided with a two-stage preheater and an ejector, and after the preheated organic waste is mixed with the high-temperature and high-pressure supercritical thermal fluid, the subcritical temperature section can be skipped to achieve the purpose of corrosion inhibition in the preheating section of the subcritical zone. Thus, the corrosion problem of the supercritical hydrothermal combustion treatment system can be solved at low cost, and at the same time, the hydrogen in the corrosion-inhibited organic waste supercritical hydrothermal combustion treatment system can be recycled, thereby avoiding the problem of resource waste.

The technical solutions of the disclosure will be further explained by specific embodiments. In the following embodiments, the methods are all conventional methods unless otherwise specified. Unless otherwise specified, the reagents and materials can be purchased in the market.

Specifically, a corrosion-inhibited organic waste supercritical hydrothermal combustion treatment system, as shown in the figure, includes: a reactor 9, an organic waste tank 5, an oxidant supply unit, a hydrogen supply unit, and a membrane separator 12.

The reactor 9 is used to perform supercritical hydrothermal combustion treatment on organic waste, and the reactor 9 is defined with a first inlet end and a second inlet end.

The organic waste tank 5 is used to supply the organic waste to the reactor 9, the organic waste tank 5 and the reactor 9 are connected via a first pipeline 18, and the first pipeline 18 is sequentially provided with a first-stage preheater 6, a second-stage preheater 7 and an ejector 8. A material pump 16 is further provided on the first pipeline 18 between the organic waste tank 5 and the first-stage preheater 6. The first-stage preheater 6 is provided with a first outlet end and a second outlet end. The second-stage preheater 7 is provided with a first outlet end, a second outlet end, a first inlet end and a second inlet end. The ejector 8 is provided with a first inlet end and a second inlet end. The first pipeline 18 is connected to the first outlet end of the first-stage preheater 6, the first inlet end and the first outlet end of the second-stage preheater 7 and the first inlet end of the ejector 8. A material outlet end of the reactor 9 is further connected to the second inlet end of the ejector 8 through a second pipeline 19.

The oxidant supply unit is used to provide oxygen for the supercritical hydrothermal combustion treatment. The oxidant supply unit supplies oxygen to the reactor 9, and at the same time, the oxygen is introduced into the first pipeline 18 between the first-stage preheater 6 and the second-stage preheater 7. When oxygen is supplied to the reactor 9, it is connected to the second inlet end of the reactor 9, and when oxygen is supplied to the first pipeline 18, it is connected to the first inlet end of the second-stage preheater 7.

The hydrogen supply unit is used to provide hydrogen to overcome the corrosion problem of the organic waste supercritical hydrothermal combustion treatment system, and the hydrogen supply unit is connected to the material outlet end of the reactor 9.

The membrane separator 12 is used to recover hydrogen in the organic waste supercritical hydrothermal combustion treatment system. The membrane separator 12 is provided with a first outlet end and a second outlet end. The membrane separator 12 is arranged on a third pipeline 20, and both ends of the third pipeline 20 are respectively connected to the material outlet end of the reactor 9 and the hydrogen supply unit. A product separator 11 is further arranged on the third pipeline 20 between the material outlet end of the reactor 9 and the membrane separator 12, and a gas phase product outlet and a non-gas phase product outlet are arranged on the product separator 11.

The third pipeline 20 is connected to a fourth pipeline 21, and an outer pipeline 25 of the first-stage preheater 6 and an outer pipeline 26 of the second-stage preheater 7 are installed on the third pipeline 20. The corrosion-inhibited supercritical thermal fluid enters the second-stage preheater 7 through the second inlet end of the second-stage preheater 7, then flows through the fourth pipeline 21, enters the first-stage preheater 6 through the second inlet end of the first-stage preheater 6, and is conveyed to the feedwater heater 10 after exchanging heat with the first-stage preheater 6 and the second-stage preheater 7.

In an embodiment, the hydrogen supply unit includes a liquid hydrogen tank 1 and a liquid hydrogen vaporizer 2, a fifth pipeline 22 is connected between the liquid hydrogen tank 1 and the material outlet end of the reactor 9, the liquid hydrogen vaporizer 2 is arranged on the fifth pipeline 22, and a liquid hydrogen pump 14 is further arranged on the fifth pipeline 22 between the liquid hydrogen tank 1 and the liquid hydrogen vaporizer 2.

On the third pipeline 20, the first outlet end of the membrane separator 12 is connected to the fifth pipeline 22, and the first outlet end of the membrane separator 12 is connected to the inlet of a pressurizing pump 17 arranged between the first outlet end of the membrane separator 12 and the fifth pipeline 22.

In an embodiment, a feedwater heater 10 is provided on the third pipeline 20 between the reactor 9 and the product separator 11.

In an embodiment, the inlet end of the feedwater heater 10 is provided with a second oxidation-reduction potential meter ORP2, which is interlocked with the liquid hydrogen pump 14. By controlling the hydrogen supply volume from the hydrogen supply unit, the oxidation- reduction potential of the cooling fluid at the outlet of the outer pipeline 25 of the first-stage preheater 6 is maintained at or below –0.2 V, ensuring that the electrochemical potential of the metallic material in the outer pipeline 25 remains within its passivation range.

In an embodiment, the oxidant supply unit includes a liquid oxygen tank 3 and a liquid oxygen vaporizer 4, a sixth pipeline 23 is connected between the liquid oxygen tank 3 and the reactor 9, the liquid oxygen vaporizer 4 is arranged on the sixth pipeline 23, and a liquid oxygen pump 15 is further arranged on the sixth pipeline 23 between the liquid oxygen tank 3 and the liquid oxygen vaporizer 4.

In an embodiment, a seventh pipeline 24 is arranged between the sixth pipeline 23 and the first pipeline 18, the seventh pipeline 24 is located between the first-stage preheater 6 and the second-stage preheater 7, and the seventh pipeline 24 is provided with a first switch valve V1. The outlet end of the second-stage preheater 7 is provided with a first oxidation-reduction potential tester ORP1, which is interlocked with the first switch valve V1. By adjusting the opening of the first switch valve, the oxidation-reduction potential at the outlet of the second-stage preheater is maintained at no less than –0.7 V, thereby mitigating the risk of stress corrosion cracking caused by hydrogen embrittlement within the second-stage preheater.

In an embodiment, the second pipeline 19 is provided with a third switch valve V3, the first inlet end of the reactor 9 is provided with a first thermometer T1, and the first thermometer T1 is interlocked with the third switch valve V3.

In an embodiment, the fourth pipeline 20 is provided with a second switch valve V2 between the second-stage preheater 7 and the first-stage preheater 6, the first inlet end of the ejector 8 is provided with a second thermometer T2, and the second thermometer T2 is interlocked with the second switch valve V2. The second thermometer controls the outlet temperature of the second-stage preheater to ensure it does not exceed 270℃.

In an embodiment, the first-stage preheater 6, the second-stage preheater 7, the reactor 9 and the product separator 11 are internally provided with integrated temperature sensor and pressure sensors TP1, TP2, TP3, TP4 respectively.

In an embodiment, the second outlet end of the product separator 11 is connected to a pressure reducer 13.

Application method

The corrosion-inhibited organic waste supercritical hydrothermal combustion treatment system of the disclosure is used for treating organic waste, which includes steps as follows. The organic waste in the organic waste tank 5 is preheated by the first-stage preheater 6 and the second-stage preheater 7 in turn to obtain preheated organic waste, and the preheated organic waste is mixed with the high-temperature and high-pressure supercritical thermal fluid discharged from the material outlet end of the reactor 9 in the ejector 8 and transported to the reactor 9.

After the oxygen in the liquid oxygen tank 3 is discharged through the liquid oxygen pump 15 and the liquid oxygen vaporizer 4 in turn, one way is delivered to the reactor 9 for supercritical hydrothermal combustion treatment, and the other way is delivered to the first pipeline 18 through the seventh pipeline 24, so that the organic waste is partially oxidized in the first pipeline 18, and the heat generated by oxidation promotes the preheating process of the second-stage preheater 7, which also solves the problem that the organic waste in the second-stage preheater 7 contains too many reducing substances and effectively prevents the risk of hydrogen embrittlement cracking in the second-stage preheater 7.

The hydrogen in the liquid hydrogen tank 1 is discharged through the liquid hydrogen pump 14 and the liquid hydrogen vaporizer 2 in turn, and then mixed with the high-temperature and high-pressure supercritical thermal fluid to obtain the corrosion-inhibited supercritical thermal fluid. During the transportation of the corrosion-inhibited supercritical thermal fluid, the hydrogen reduces the oxidation-reduction potential of the cooling section in the subcritical zone.

The corrosion-inhibited supercritical thermal fluid is conveyed to the ejector 8 through the second pipeline 19, and the ejector 8 ejects the high-temperature and high-pressure supercritical thermal fluid at the material outlet end of the reactor 9. Another path is conveyed to the third pipeline 20, and exchanges heat with the second-stage preheater 7 and the first-stage preheater 6 in turn to obtain the cooling fluid. Still another path is transported through the fourth pipeline 21, and the cooling fluid and the corrosion-inhibited supercritical thermal fluid are mixed in the third pipeline 20, and are sent to the feedwater heater 10 together to exchange heat with external water to obtain heat exchange fluid.

The heat exchange fluid is delivered to the product separator 11, and the product separator 11 discharges the gas phase product into the membrane separator 12 for hydrogen recovery and reuse, while the non-gas phase product is discharged, and the recovered hydrogen enters the fifth pipeline 22 and is mixed with the hydrogen in the fifth pipeline 22.

Apparently, those skilled in the art can make various modifications and variations to the disclosure without departing from the spirit and scope of the disclosure. Thus, if these modifications and variations of the disclosure are within the scope of the claims and their equivalents, it is intended that the disclosure also include these modifications and variations. The above-mentioned embodiments are only illustrated embodiments for fully explaining the disclosure, and its protection scope is not limited to this. Equivalent substitutions or transformations made by those skilled in the art on the basis of the disclosure are all within the scope of protection of the disclosure, which shall be subject to the claims.

What is claimed is:

1. A corrosion-inhibited organic waste supercritical hydrothermal combustion treatment system, comprising:
a reactor (9), configured to perform supercritical hydrothermal combustion treatment on organic waste;
an organic waste tank (5), configured to supply the organic waste to the reactor (9), wherein the organic waste tank (5) and the reactor (9) are connected via a first pipeline (18), and the first pipeline (18) is sequentially provided with a first-stage preheater (6), a second-stage preheater (7), and an ejector (8); a material outlet end of the reactor (9) is further connected to the ejector (8) via a second pipeline (19), and the ejector (8) is configured to inject supercritical thermal fluid from the material outlet end of the reactor (9);
an oxidant supply unit, configured to provide oxygen for the supercritical hydrothermal combustion treatment, wherein the oxidant supply unit is further configured to introduce the oxygen into the first pipeline (18) between the first-stage preheater (6) and the second-stage preheater (7) during supplying the oxygen to the reactor (9);
a hydrogen supply unit, connected to the material outlet end of the reactor (9); and
a membrane separator (12), configured to recover hydrogen from the corrosion-inhibited organic waste supercritical hydrothermal combustion treatment system, wherein the membrane separator (12) is disposed on a third pipeline (20), and two ends of the third pipeline (20) are connected the material outlet end of the reactor (9) and the hydrogen supply unit, respectively; a product separator (11) is further provided on the third pipeline (20) between the reactor (9) and the membrane separator (12); and
wherein the third pipeline (20) is connected to a fourth pipeline (21), and an outer pipeline of each of the first-stage preheater (6) and the second-stage preheater (7) is installed on the third pipeline (20); the hydrogen supply unit is configured to provide the hydrogen to reduce an oxidation-reduction potential in a subcritical zone cooling section of the corrosion-inhibited organic waste supercritical hydrothermal combustion treatment system, and the outer pipeline of each of the first-stage preheater (6) and the second-stage preheater (7) is the subcritical zone cooling section.

2. The corrosion-inhibited organic waste supercritical hydrothermal combustion treatment system as claimed in claim 1, wherein the hydrogen supply unit comprises a liquid hydrogen tank (1) and a liquid hydrogen vaporizer (2), the liquid hydrogen tank (1) is connected to the material outlet end of the reactor (9) via a fifth pipeline (22), the liquid hydrogen vaporizer (2) is disposed on the fifth pipeline (22), and a liquid hydrogen pump (14) is further provided on the fifth pipeline (22) between the liquid hydrogen tank (1) and the liquid hydrogen vaporizer (2); and
the third pipeline (20) is connected to the fifth pipeline (22) at an outlet end of the membrane separator (12).

3. The corrosion-inhibited organic waste supercritical hydrothermal combustion treatment system as claimed in claim 2, wherein a feedwater heater (10) is further provided on the third pipeline (20) between the reactor (9) and the product separator (11).

4. The corrosion-inhibited organic waste supercritical hydrothermal combustion treatment system as claimed in claim 3, wherein a second oxidation-reduction potential meter (ORP2) is provided at an inlet end of the feedwater heater (10), and the second oxidation-reduction potential meter (ORP2) is interlocked with the liquid hydrogen pump (14).

5. The corrosion-inhibited organic waste supercritical hydrothermal combustion treatment system as claimed in claim 1, wherein the oxidant supply unit comprises a liquid oxygen tank (3) and a liquid oxygen vaporizer (4), the liquid oxygen tank (3) is connected to the reactor (9) via a sixth pipeline (23), the liquid oxygen vaporizer (4) is disposed on the sixth pipeline (23), and a liquid oxygen pump (15) is further provided on the sixth pipeline (23) between the liquid oxygen tank (3) and the liquid oxygen vaporizer (4).

6. The corrosion-inhibited organic waste supercritical hydrothermal combustion treatment system as claimed in claim 5, wherein a seventh pipeline (24) is provided between the fifth pipeline (23) and the first pipeline (18), the seventh pipeline (24) is located between the first-stage preheater (6) and the second-stage preheater (7), a first switch valve (V1) is provided on the sixth pipeline (24), a first oxidation-reduction potential meter (ORP1) is provided at an outlet end of the second-stage preheater (7), and the first oxidation-reduction potential meter (ORP1) is interlocked with the first switch valve (V1).

7. The corrosion-inhibited organic waste supercritical hydrothermal combustion treatment system as claimed in claim 1, wherein a third switch valve (V3) is provided on the second pipeline (19), a first thermometer (T1) is provided at an inlet end of the reactor (9) between the ejector (8) and the reactor (9), and the first thermometer (T1) is interlocked with the third switch valve (V3).

8. The corrosion-inhibited organic waste supercritical hydrothermal combustion treatment system as claimed in claim 1, wherein a second switch valve (V2) is provided on the fourth pipeline (21) between the second-stage preheater (7) and the first-stage preheater (6), a second thermometer (T2) is provided at an inlet end of the ejector (8) between the second-stage preheater (7) and the ejector (8), and the second thermometer (T2) is interlocked with the second switch valve (V2).

9. The corrosion-inhibited organic waste supercritical hydrothermal combustion treatment system as claimed in claim 1, wherein each of the first-stage preheater (6), the second-stage preheater (7), the reactor (9), and the product separator (11) is internally provided with a temperature and pressure sensor.

10. The corrosion-inhibited organic waste supercritical hydrothermal combustion treatment system as claimed in claim 1, wherein the product separator (11) is further connected to a pressure reducer (13).
